(19) United States
(12) Patent Application Publication
(10) Pub. No.: US 2009/0040606 A1
(43) Pub. Date: Feb. 12, 2009

(54) 3-DIMENSIONAL MOVING IMAGE PHOTOGRAPHING DEVICE FOR PHOTOGRAPHING NEIGHBORING OBJECT

(76) Inventor: Young Hwa Lee, Seoul (KR)

Correspondence Address: Jason Y. Pahng and Associates, LLC, 12178 Bridgend Run, Fairfax, VA, 22030, US

(21) Appl. No.: 12/162,482

(22) PCT Filed: Feb. 14, 2007
(86) PCT No.: PCT/KR2007/000782

§ 371 Date: Jul. 28, 2008

(30) Foreign Application Priority Data
Feb. 27, 2006 (KR) 10-2006-0018658

(51) Int. Cl. G02B 27/22

(52) U.S. Cl. 359/476

(57) ABSTRACT

Disclosed is a three-dimensional moving image producing device including a probe including a group of object lenses, a group of relay lenses, and a group of eye lenses arranged in sequence, a camera body located at the rear side of the probe and including a group of magnifying lenses for enlarging an image introduced into the camera body through the probe, and a group of camera lenses and a charge coupled device (CCD) camera for capturing the image, and a transparent panel provided in a space defining an entrance pupil of the group of camera lenses between the probe and the camera body, the transparent panel being tilted by a predetermined inclination angle with respect to an optical axis of the group of camera lenses and having a predetermined refractive index. The transparent panel periodically intercepts around the optical axis of the group of camera lenses. With this configuration, the transparent panel periodically refracts an image passed through the group of eye lenses or passes the image without refraction, so as to acquire two left and right images having different viewpoints from each other. By combining the two images with each other, a three-dimensional image can be produced.

### TECHNICAL FIELD

The present invention relates to a three-dimensional moving image producing device for producing a three-dimensional moving image, and more particularly, to a three-dimensional moving image producing device suitable for the close-up photographing of a neighboring object or for high-precision photographing of the neighboring object.

### BACKGROUND ART

As representative examples of the prior art associated with the present invention, there are Korean Patent Laid-open Publication No. 10-2000-0015158 (hereinafter, referred to as “prior art document 1”) and Korean Patent Laid-open Publication No. 10-1999-0085766 (hereinafter, referred to as “prior art document 2”).

Recently, the close-up photographing of an object has been widely used in a variety of industrial fields. For example, an optical microscope is used to inspect micro-tissues of plants and animals or damaged parts of mechanical materials, and also is used to inspect high-density integrated semiconductor chips or semiconductor circuits and couplings between the semiconductor chips or circuits and electronic micro-elements. Other examples include a laparoscope used to perform a surgery on an inner injured part of the human body through a small incision in the abdominal wall, and an endoscope used to examine an inner part of the human body that is invisible by the naked eyes.

Meanwhile, for the understanding of the accurate structure and shape of an object to be photographed, it is necessary to acquire a three-dimensional moving image of the object suitable for providing a viewer with near-far and large-small senses, rather than a two-dimensional planar moving image. For example, in the case of a precise and delicate surgery using a laparoscope, there is a limit to understand the structure or position of an inner injured part of the human body because the laparoscope provides only a planar moving image having no near-far and large-small senses. It is difficult to perform a precise surgery while viewing the planar moving image.

As shown in FIG. 1, it is general that the eyes 10 of a viewer are spaced apart from each other by a distance D of approximately 65 mm. If the eyes 10 watch an object 1 located in front of the eyes 10 at a distance d of approximately 500 mm, the eyes 10 can recognize the object 1 three-dimensionally without any fatigue in a state wherein an included angle θ between the eyes 10 and the object 1 is approximately 7.44 degrees. Similar to the human eyes shown in FIG. 1, a general three-dimensional moving image producing device is configured such that it photographs and recognizes left and right images of an object separately, thereby producing a three-dimensional image by composing the images. For this, the three-dimensional moving image producing device uses two groups of lenses arranged at left and right sides of the object to obtain the left and right images of the object. Also, the three-dimensional moving image producing device is designed to maintain a predetermined ratio of the distance D between the left and right groups of lenses corresponding to the eyes 10 of FIG. 1 to the distance d between the groups of lenses and the object 1, and more particularly, to determine a focus on the basis of the angle θ of approximately 7.44 degrees.

In the case of photographing a neighboring object, the distance d between the groups of lenses and the object 1 is shortened. However, it is preferable that the above described angle θ be maintained at approximately 7.44 degrees to acquire a three-dimensional image that can be most comfortably recognized by the human eyes. Accordingly, if the distance d between the groups of lenses and the object 1 is shortened, the distance D between the left group of lenses and the right group of lenses has to be shortened. For example, if the distance d between the groups of lenses and the neighboring object 1 is 5 mm, the distance D between both the groups of lenses has to be 0.65 mm, in order to acquire a three-dimensional image causing no fatigue to the viewer's eyes. However, when the distance D between both the groups of lenses is 0.65 mm, there is a problem in that the diameter of each lens should be extremely small and thus, the processing of the lens is difficult. Furthermore, when the diameter of the lens has a fixed constant value, the distance d between the lens and the object should be lengthened, for the acquisition of a three-dimensional image causing no fatigue to the viewer's eyes. This makes it impossible to acquire an optimal image with respect to the neighboring object.

FIG. 2 is a view illustrating a conventional three-dimensional moving image producing device for photographing a neighboring object as disclosed in the above mentioned prior art document 1, which is mainly applicable to a laparoscope apparatus. As shown in FIG. 2, in the conventional three-dimensional moving image producing device, two groups of lenses 110; 110a and 110b are arranged in a probe 100 at left and right positions to form left and right images of a neighboring object. The left and right images, introduced into the device through the respective groups of lenses 110a and 110b, are reflected by a reflective prism 120 and reflective mirrors 130a and 130b, and subsequently, captured by left and right image sensor units 140a and 140b by way of left and right filters 150a and 150b. As the left and right image sensor units 140a and 140b combine the left and right images with each other, a three-dimensional image can be produced. A problem of the conventional three-dimensional moving image producing device for use in a laparoscope apparatus having the above described configuration is that the two groups of lenses 110a and 110b are arranged at a distance from each other within the probe 100, therefore the probe 100 should have a large diameter corresponding to the sizes of the lenses. Another problem is that the greater the distance D between the two groups of lenses, the greater the distance between the lenses and an object for the acquisition of an optimal three-dimensional image causing no fatigue to the viewer's eyes, therefore it is difficult to photograph a neighboring object located close to the lenses at a distance less than the predetermined distance d.

FIG. 3 is a view illustrating another conventional three-dimensional moving image producing device for photographing a neighboring object as disclosed in the above mentioned prior art document 2, which is mainly applicable to an endoscope apparatus. As shown in FIG. 3, in the conventional three-dimensional moving image producing device, a single group of lenses 210 is arranged in a probe 200 to form a single image, and in turn, the single image, introduced into the device through the group of lenses 210, is divided into two left and right images by a prism 220. The divided left and right images are reflected by reflective mirrors 230, respectively. Magnifying lenses 250 and camera lenses 240 are installed in paths of the left and right images, to recognize and combine the left and right images, so as to produce a three-dimensional image. The three-dimensional moving image producing device having the above described configuration has the function of close-up photographing because only the single group of lenses 210 is installed in the probe 200 to thereby guarantee a short distance between the lenses 210 and the neighboring object. However, in the above described image producing method wherein a single image having a single bundle of light (flux of light) is divided into left and right images and then, again combined with each other, there is a problem in that the combined image has a deterioration of accuracy as compared to a three-dimensional image produced by combining a left image having a single flux of light and a right image having a single flux of light with each other. Further, since the conventional three-dimensional moving image producing device uses the left and right magnifying lenses 250 for the respective left and right images, it is necessary to adjust both the magnifying lenses 250 simultaneously for applying the same magnification to the left and right images. If the left and right images have different magnifications from each other, it is impossible to combine the images into an integrated single image.

### DISCLOSURE

### Technical Problem

Therefore, the present invention has been made in view of the above problems, and it is an object of the present invention to provide a three-dimensional moving image producing device which can reduce the diameter of a probe by arranging only a single group of lenses inside the probe, and has the function of periodically converting an optical axis of incident light and capturing left and right images viewed from two viewpoints caused by the converted optical axis, thereby enabling the close-up photographing of a neighboring object.

It is another object of the present invention to provide a three-dimensional moving image producing device in which the position of a viewpoint can be adjusted by converting an optical axis of a single bundle of incident light without separation, thereby acquiring left and right images from the single bundle of incident light, and in which a single magnifying lens is used for both the left and right images, thus resulting in an easy adjustment in the magnification of the images.

### Technical Solution

In accordance with an aspect of the present invention, the above and other objects can be accomplished by the provision of a three-dimensional moving image producing device comprising: a probe including a group of object lenses, a group of relay lenses, and a group of eye lenses arranged in sequence; and a camera body located at the rear side of the probe and including a group of magnifying lenses for enlarging an image introduced into the camera body through the probe, and a group of camera lenses and a charge coupled device (CCD) camera for capturing the image, the device further comprising: a transparent panel provided in a space defining an entrance pupil of the group of camera lenses between the probe and the camera body, the transparent panel being tilted by a predetermined inclination angle with respect to an optical axis of the group of camera lenses and having a predetermined refractive index, wherein the transparent panel periodically intercepts around the optical axis of the group of camera lenses. With this configuration, the transparent panel periodically refracts an image, passed through the group of eye lenses, or passes the image without refraction, so as to produce two left and right images having different viewpoints from each other. By combining the two images with each other, a three-dimensional image can be produced.

The transparent panel may be divided into two parts including a refracting part having the predetermined refractive index and adapted to refract an image introduced into the transparent panel and a passage part to pass the image without refraction. The transparent panel may be rotated by a rotating drive unit connected to a rotating shaft of the transparent panel such that the refracting part or the passage part periodically refracts or passages the image passed through the group of eye lenses. With rotation of the transparent panel, the image introduced into the transparent panel can be refracted by or passed through the transparent panel.

The refracting part and the passage part of the transparent panel are located right in the front side of or in the rear side of the entrance pupil of the group of camera lenses. With this configuration, it is possible to reduce the size of the transparent panel.

The transparent panel may comprise a passage part and a plurality of refracting parts having different thicknesses from one another. With this configuration, it is possible to produce a plurality of images with respect to an object viewed from several different viewpoints.

The transparent panel may comprise a passage part and a plurality of refracting parts having different refractive indices from one another. With this configuration, it is possible to produce a plurality of images with respect to an object viewed from several different viewpoints.

The rotating drive unit for rotating the transparent panel may have revolutions per minute determined by a vertical synchronizing frequency signal transmitted from the CCD camera of the camera body. Accordingly, it is possible to synchronize the frame cycle of the CCD camera with the refraction cycle of the image.

An installation angle of the transparent panel may be changed with respect to an optical axis of the group of camera lenses. This enables a regulation in the relative positions of viewpoints, so as to acquire a three-dimensional image without causing any fatigue to the viewer's eyes regardless of a distance between a neighboring object to be photographed and the viewpoints.

The refracting part and the passage part of the transparent panel may be located right in the front side of or in the rear side of the entrance pupil of the group of camera lenses. With this configuration, it is possible to reduce the size of the transparent panel.

### DESCRIPTION OF DRAWINGS

The above and other objects, features and other advantages of the present invention will be more clearly understood from the following detailed description taken in conjunction with the accompanying drawings, in which:

FIG. 1 is a view illustrating human eyes watching an object;

FIG. 2 is a view illustrating a conventional three-dimensional moving image producing device for photographing a neighboring object;

FIG. 3 is a view illustrating another conventional three-dimensional moving image producing device for photographing a neighboring object;

FIG. 4 is a view illustrating a three-dimensional moving image producing device according to the present invention;

FIG. 5 is an enlarged view illustrating the configuration of a transparent panel shown in FIG. 4;

FIG. 6 is a view illustrating the operation of the transparent panel of FIG. 5;

FIG. 7 is a view illustrating the operation of the three-dimensional moving image producing device;

FIG. 8 is a view illustrating left and right images produced by a CCD camera under the operation of the three-dimensional moving image producing device according to the present invention;

FIG. 9 is a view illustrating the operation of the three-dimensional moving image producing device according to the present invention in consideration of a change in the installation angle of the transparent panel;

FIG. 10 is a view illustrating a transparent panel having a plurality of refracting parts according to another embodiment of the present invention;

FIG. 11 is a view illustrating one example in which the plurality of refracting parts included in the transparent panel of FIG. 10 have different refractive indices from one another;

FIG. 12 is a view illustrating another example in which the plurality of refracting parts included in the transparent panel of FIG. 10 have the same refractive index as one another, but have different thicknesses from one another; and

FIG. 13 is a view illustrating images formed by a CCD camera via the operations as shown in FIGS. 11 and 12.

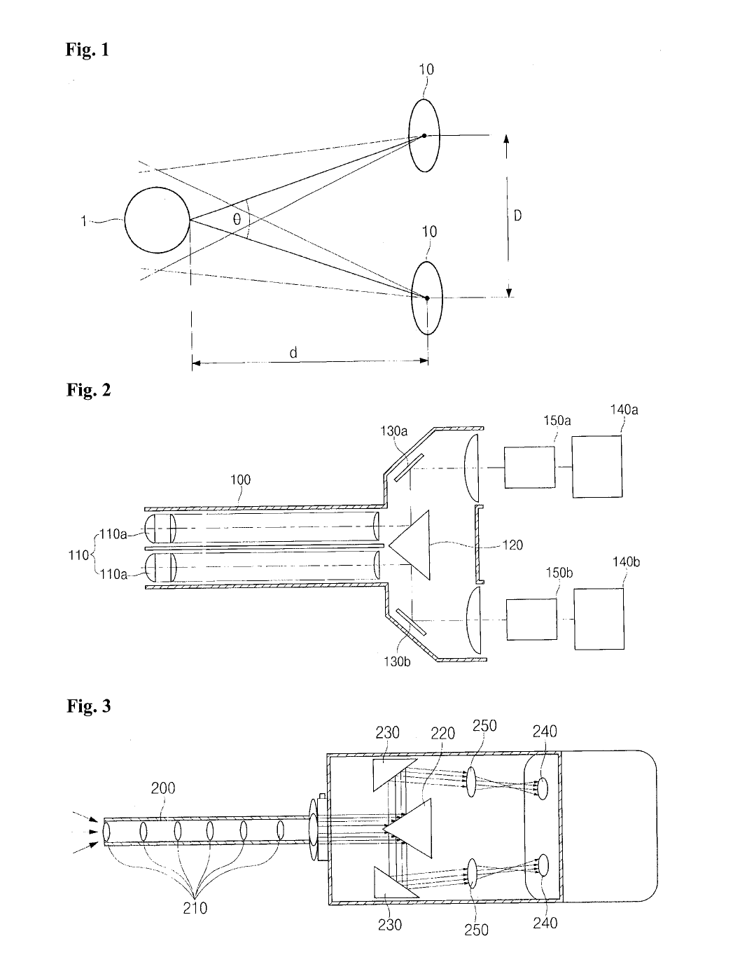

### BEST MODE

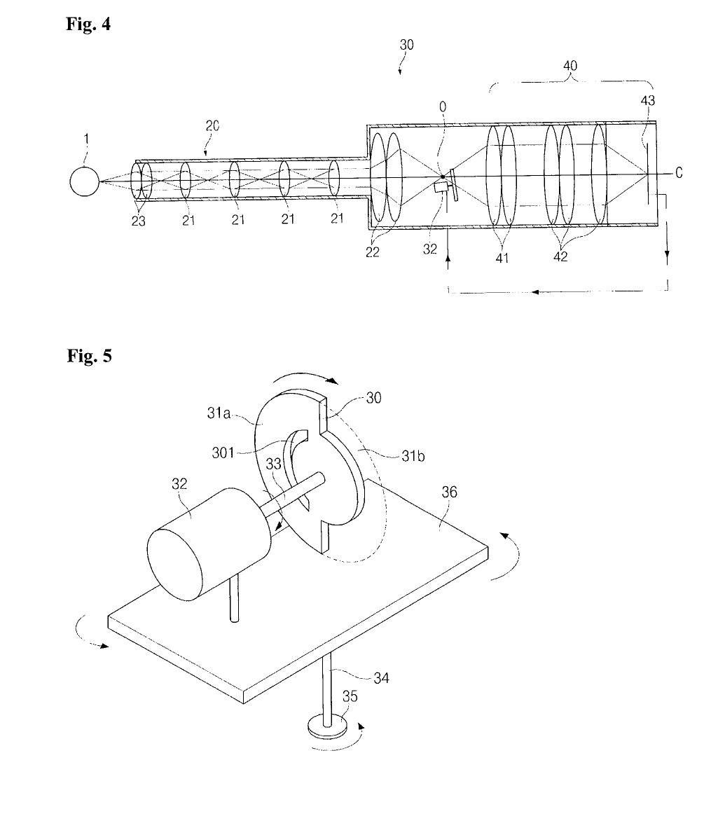

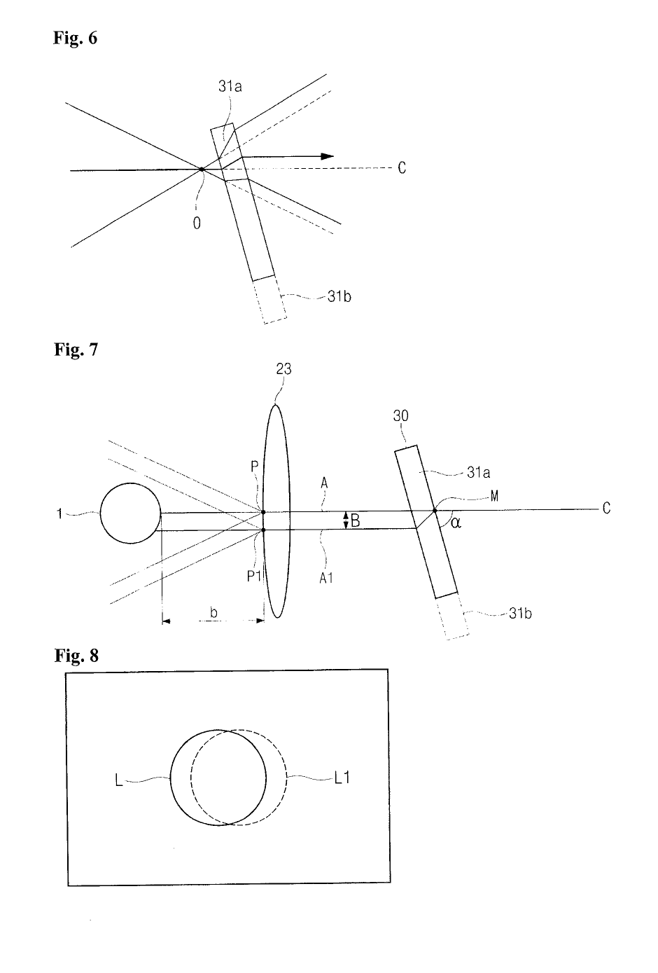

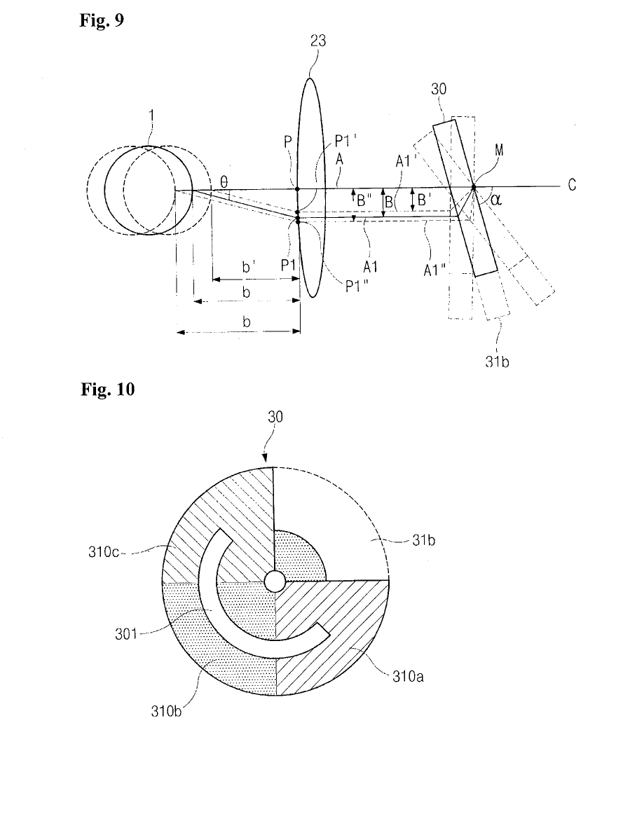

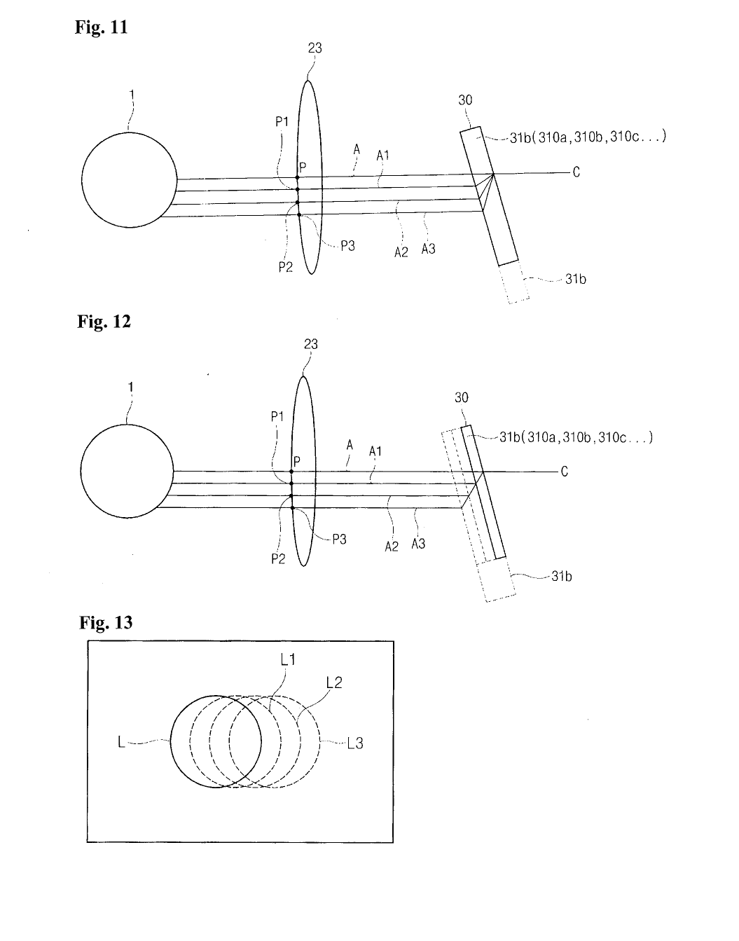

Now, preferred embodiments of the present invention will be described in detail with reference to the accompanying drawings. FIG. 4 is a view illustrating a three-dimensional moving image producing device according to the present invention. FIG. 5 is an enlarged view illustrating the configuration of a transparent panel shown in FIG. 4. FIG. 6 is a view illustrating the operation of the transparent panel of FIG. 5. FIG. 7 is a view illustrating the operation of the three-dimensional moving image producing device. FIG. 8 is a view illustrating left and right images produced by a CCD camera under the operation of the three-dimensional moving image producing device according to the present invention. FIG. 9 is a view illustrating the operation of the three-dimensional moving image producing device according to the present invention in consideration of a change in the installation angle of the transparent panel. FIG. 10 is a view illustrating a transparent panel having a plurality of refracting parts according to another embodiment of the present invention. FIG. 11 is a view illustrating one example in which the plurality of refracting parts included in the transparent panel of FIG. 10 have different refractive indices from one another. FIG. 12 is a view illustrating another example in which the plurality of refracting parts included in the transparent panel of FIG. 10 have the same refractive index as one another, but have different thicknesses from one another. FIG. 13 is a view illustrating images formed by a CCD camera via the operations as shown in FIGS. 11 and 12.

Referring first to FIG. 4, a three-dimensional moving image producing device according to the present invention comprises a probe 20 located close to an object 1 and adapted to take an image of the object 1, a camera body 40 to enlarge and capture the image taken by the probe 20, and a transparent panel 30 installed in a space between the probe 20 and the camera body 40.

The probe 20 includes a group of object lenses 23 installed at a tip end of the probe 20, a group of relay lenses 21 arranged at the rear side of the group of object lenses 23 such that a plurality of relay lenses are spaced apart from each other by a predetermined distance, and a group of eye lenses 22 arranged at the rear side of the group of relay lenses 21. The camera body 40 includes a group of magnifying lenses 41 arranged in a front position of the camera body 40 and adapted to enlarge the taken image, a group of camera lenses 42 arranged at the rear side of the group of the magnifying lenses 41, and a charge coupled device (CCD) camera 43 to capture the image. The image, taken by the probe 20, is refracted through the group of eye lenses 22, and thereafter, enters the group of camera lenses 42 by way of the group of magnifying lenses 41. A movable point for the convergence and diffusion of the image is defined between the group of eye lenses 22 and the group of magnifying lenses 41. The movable point is called “entrance pupil” O of the group of camera lenses 42.

The transparent panel 30 is installed near the entrance pupil defined in the space between the probe 20 and the camera body 40. The transparent panel 30 is tilted by a predetermined inclination angle with respect to an optical axis C of the group of camera lenses 42, so as to selectively intercept around the optical axis C with a predetermined period. For this, the transparent panel 30 of the present embodiment, as shown in FIG. 5, takes the form of a circular plate made of a transparent material having a predetermined refractive index. The transparent panel 30 is divided, about a center axis thereof, into two parts. One of the divided parts defines a refracting part 31 having the refractive index, and the other part is an empty space defining a passage part 31b. The transparent panel 30 is rotated by a rotating drive unit 32 such as a rotating motor, etc. connected to a rotating shaft 33. If the transparent panel 30 is rotated by the rotating drive unit 32 such that the refracting part 31 intercepts around the optical axis C of the group of camera lenses 42, an image, introduced into the transparent panel 30, is refracted on the basis of the refractive index of the refracting part 31a (as designated by solid lines in FIG. 6). When the passage part 31b is located on the optical axis C of the group of camera lenses 42, the image passes through the transparent panel 30 without refraction (as designated by dotted lines in FIG. 6). Thereby, with the periodical rotation of the transparent panel 30, two images including a refracted image and a non-refracted image can be produced. The refracted image and non-refracted image are captured, by the CCD camera 43, as two left and right images L and L1 as shown in FIG. 8. As the CCD camera 43 combines the images L and L1 with each other, a three-dimensional image can be produced.

Revolutions per minute of the rotating drive unit 32 shown in FIG. 4 are determined depending on a vertical synchronizing frequency signal transmitted from the CCD camera 43 of the camera body 40. The vertical synchronizing frequency signal is generated when the CCD camera 43 photographs a frame after completely photographing a previous frame. Accordingly, the transparent panel 30 is rotated on the basis of a change period of a frame to be photographed, such that the refracted image and non-refracted image can be stored in respective frames. In the present embodiment in which the transparent panel 30 is divided into two parts including the refracting part 31a and the passage part 31b, it is preferable that the rotating drive unit 32 be controlled to rotate the transparent panel 30 a half-turn on the basis of the vertical synchronizing frequency signal.

Preferably, the transparent panel 30, as shown in FIG. 6, is arranged such that the refracting part 31a and the passage part 31b are positioned right in the front side or in the rear side of the entrance pupil O of the group of camera lenses 42. If an image is introduced into the entrance pupil O, the entrance pupil O serves to converge and diffuse the image. Therefore, by arranging the transparent panel 30 near the entrance pupil O, the transparent panel 30 can refract the image in a state prior to or after being converged even if the transparent panel 30 has a small size. This has the effect of allowing a reduction in the size of the transparent panel 30.

In FIG. 5, reference numeral 301 denotes an empty space defined in the refracting part 31a for compensating for weight imbalance between the passage part 31b in the form of an empty space and the refracting part 31a. Preferably, the size of the empty space 301 is determined so as not to interfere with the passage of the image through the refracting part 31a.

For the sake of an easier explanation of the principle for producing left and right images using the three-dimensional moving image producing device of the present invention, hereinafter, the change of an image passing through the transparent panel 30 will be described on the basis of the camera body 40. First, as shown in FIG. 7, when an image is introduced into the transparent panel 30 so as to pass through the passage part 31b of the transparent panel 30, the image is introduced directly into the camera body 40 without refraction, and it will be appreciated that the image is introduced along an axis A coinciding with the optical axis C in the region of the probe 20. On the other hand, when an image is introduced into the transparent panel 30 so as to pass through the refracting part 31a of the transparent panel 30, the image is introduced into the camera body 40 after being refracted by the refracting part 31a, and it will be appreciated that the image is introduced along an axis A1 having a different position from that of the optical axis C in the region of the probe 20. Accordingly, the axis A is spaced apart from the refracting axis A1 by a distance B. As a result, two viewpoints P and P1, having different positions from each other, are formed on the group of object lenses 23 located in the foremost region of the probe 20. When watching the object 1 from the viewpoints P and P1 spaced apart from each other by a distance B, left and right images of the object 1 can be acquired, and the left and right images of the object 1 are introduced through the axes A and A1, respectively. In the three-dimensional moving image producing device of the present invention, the left and right images are alternately captured via the transparent panel 30 such that the images L and L1 having different positions from each other, as shown in FIG. 8, can be produced by the CCD camera 43. As the CCD camera 43 combines the left and right images L and L1 with each other, a three-dimensional image can be produced.

The distance B between both the viewpoints P and P1 can be adjusted by changing an installation angle α of the transparent panel 30 with respect to the optical axis C of the group of camera lenses 42. More specifically, if the installation angle α of the transparent panel 30 is changed, an image refracting angle on the refracting part 31a having the same refraction index as that of the transparent panel 30 is changed. Therefore, as shown in FIG. 9, the refracting axis A1 is shifted to an axis A1′ or A1″. This may cause the distance B between the axis A penetrating through the passage part 31b and the refracting axis to be changed into a distance B′ or B″, and consequently, the viewpoint P1 of the group of object lenses 23 to be changed into a viewpoint P1′ or P1″. According to the change of the viewpoint, a distance b between the object 1 and the group of object lenses 23 can be changed into a distance b′ or b″ suitable for acquiring an optimal image causing no fatigue to the viewer's eyes. In conclusion, a three-dimensional image can be produced by changing the installation angle α of the transparent panel 30 regardless of the distance b between the group of object lenses 23 and the object 1.

The present invention further employs an installation angle regulator for adjusting the installation angle α of the transparent panel 30 with respect to the optical axis C of the group of camera lenses 42. In the present embodiment, as shown in FIG. 5, the installation angle regulator includes a supporting plate 36 for supporting the transparent panel 30 and the rotating drive unit 32, and a rotating plate 35 connected to the bottom of the supporting plate 36 by means of a connecting member 34. The connecting member 34 acts as a rotating shaft and is located at a position M shown in FIG. 7. If the rotating plate 35 is rotated by the above described structure, the rotating drive unit 32 and the transparent panel 30 are rotated about the position M, thus allowing the installation angle of the transparent panel 30 with respect to the optical axis C to be changed. The rotating plate 35 is exposed out of a cover (not shown) of the three-dimensional moving image producing device such that the rotating plate 35 can be rotated manually or rotated automatically by a motor that is operable in response to an electric signal.

With the above described configuration, a user can adjust the distance B between the viewpoints P and P1 corresponding to the user's left and right eyes while rotating the rotating plate 35. Therefore, even if a distance between the object 1 to be photographed and the viewpoints P and P1 is short, the optimal left and right images can be acquired, resulting in a more accurate three-dimensional image having near-far and large-small senses without causing any fatigue to the user's eyes.

Although the above described transparent panel 30 is configured such that it is rotated by the rotating drive unit 32 to periodically intercept around the optical axis C of the group of camera lenses 42, those skilled in the art will be appreciated that other methods, for example, a horizontal movement of the transparent panel 30, can be employed for intercepting around the optical axis C of the group of camera lenses 42.

Referring to FIG. 10 illustrating another embodiment of the present invention, the transparent panel 30 may have a plurality of refracting parts and a single passage part, which have the same area as one another. In the present embodiment, the transparent panel 30 is divided into four parts including three refracting parts 310a, 310b, and 301c and the passage part 31b. The plurality of refracting parts may be made of materials having different refractive indices from one another, or may be made of materials having the same refractive index as one another, but having different thicknesses from one another.

FIG. 11 is a view illustrating one example in which the plurality of refracting parts included in the transparent panel of FIG. 10 have different refractive indices from one another. Referring to FIG. 11, when an image passes through the passage part 31b and the three refracting parts 310a, 310b, and 310c having different indices from one another according to rotation of the transparent plate 30, the image is refracted to different positions from one another along axes A, A1, A2, and A3, respectively, and thus, viewpoints P, P1, P2, and P3 are formed, at different positions from one another, on the group of object lenses 23 in the probe 20. This has the effect of watching the object 1 from four viewpoints, and as shown in FIG. 13, a plurality of images L, L1, L2, and L3 of the object 1 can be acquired.

FIG. 12 is a view illustrating another example in which the plurality of refracting parts included in the transparent panel of FIG. 10 have the same refractive index as one another, but have different thicknesses from one another. Referring to FIG. 12, when an image is introduced into the passage part 31b and the refracting parts 310a, 310b, and 301c having different thicknesses from one another, the image has different refracting lengths from one another according to the thicknesses. Therefore, the axes A, A1, A2, and A3 are formed at different positions from one another. Consequently, similar to the embodiment of FIG. 11, four viewpoints P, P1, P2, and P3 can be formed on the group of object lenses 23, and as shown in FIG. 13, four images L, L1, L2, and L3 can be acquired. In the present embodiment, the transparent panel 30 is divided into four parts, and the refracting parts 310a, 301b, and 310c except for the passage part 31b have the same refractive index as one another. Also, the refracting parts 310a, 301b, and 310c have the relationship of multiple proportion, such that the respective refracting parts 310a, 301b, and 310c have thicknesses 1 T, 2T, and 3 T. Here, reference letter “T” denotes a thickness of the shallowest refracting part.

In consideration that the transparent panel shown in FIGS. 11 and 12 are divided into four parts including the plurality of refracting parts and the single passage part, the rotation cycle of the rotating drive unit is preferably determined such that the transparent member is rotated a quarter-turn on the basis of a vertical synchronizing frequency signal transmitted from the CCD camera.

With the above described configuration, several images viewed from several viewpoints around the object 1 can be acquired. By combining the images with one another, consequently, it is possible to produce a more accurate three-dimensional image of the object 1.

### INDUSTRIAL APPLICABILITY

As apparent from the above description, a three-dimensional moving image producing device according to the present invention has the following effects.

Firstly, different viewpoints with respect to an object can be obtained on the basis of on a refractive index of a transparent panel. Thereby, if left and right images of the object are acquired from the different viewpoints, the images can be alternately captured via the transparent panel, so as to produce a three-dimensional image of the object.

Secondly, by changing the refractive index or the installation angle of the transparent panel, the three-dimensional moving image producing device of the present invention can freely change the positions of the viewpoints. As a result, it is possible to guarantee an optimal distance between an object to be photographed and the viewpoints. This has the effect of producing a three-dimensional image without causing any fatigue to the user's eyes.

Thirdly, according to the present invention, the change in the positions of the viewpoints can be accomplished by the transparent panel, differently from the prior art wherein two lenses should be located at left and right sides of the object for acquiring two left and right images of the object. This has the effect of reducing the diameter of a probe.

Fourthly, the three-dimensional moving image producing device of the present invention is adapted to adjust the positions of the viewpoints via a conversion in a single bundle of incident light rather than separation of the bundle of light, for the purpose of acquiring left and right images from the single bundle of light. Further, as a result of using a single magnifying lens with respect to both the left and right images, the regulation of magnification can be simplified.

Fifthly, when using a transparent panel having a plurality of refracting parts having different refractive indices from one another, a plurality of images viewed from various viewpoints can be acquired, and a more actual image of the object can be acquired by combining the plurality of images with one another.

Sixthly, by arranging the transparent panel right in the front side of or in the rear side of a group of camera lenses, it is possible to achieve a considerable reduction in the size of the transparent panel.

Finally, the present invention is applicable to a laparoscope or endoscope apparatus used in a medical industry field, or other optical microscopes, etc., for inspecting micro tissues three-dimensionally, and also is usable in the three-dimensional photographing of a micro-structure in other industrial fields.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-8. (canceled)

9. A three-dimensional moving image producing device comprising: a probe including a group of object lenses, a group of relay lenses, and a group of eye lenses arranged in sequence; and a camera body located at the rear side of the probe and including a group of magnifying lenses for enlarging an image introduced into the camera body through the probe, and a group of camera lenses and a charge coupled device (CCD) camera for capturing the image, the device further comprising:
a transparent panel provided in a space defining an entrance pupil of the group of camera lenses between the probe and the camera body, the transparent panel being tilted by a predetermined inclination angle with respect to an optical axis of the group of camera lenses and having a predetermined refractive index,
wherein the transparent panel periodically intercepts around the optical axis of the group of camera lenses.

10. The device according to claim 9, wherein an installation angle of the transparent panel is changed with respect to an optical axis of the group of camera lenses.

11. The device according to claim 9, wherein
the transparent panel is divided into two parts including a refracting part having the predetermined refractive index and adapted to refract an image introduced into the transparent panel and a passage part to pass the image without refraction, and
the transparent panel is rotated by a rotating drive unit connected to a rotating shaft of the transparent panel such that the refracting part and the passage part periodically refracts or passages the image passed through the group of eye lenses.

12. The device according to claim 11, wherein an installation angle of the transparent panel is changed with respect to an optical axis of the group of camera lenses.

13. The device according to claim 11, wherein the rotating drive unit for rotating the transparent panel has revolutions per minute determined by a vertical synchronizing frequency signal transmitted from the CCD camera of the camera body.

14. The device according to claim 13, wherein an installation angle of the transparent panel is changed with respect to an optical axis of the group of camera lenses.

15. The device according to claim 11, wherein the refracting part and the passage part of the transparent panel are located right in the front side of or in the rear side of the entrance pupil of the group of camera lenses.

16. The device according to claim 15, wherein the rotating drive unit for rotating the transparent panel has revolutions per minute determined by a vertical synchronizing frequency signal transmitted from the CCD camera of the camera body.

17. The device according to claim 15, wherein an installation angle of the transparent panel is changed with respect to an optical axis of the group of camera lenses.

18. The device according to claim 15, wherein the transparent panel comprises a passage part and a plurality of refracting parts having different thicknesses from one another.

19. The device according to claim 18, wherein the rotating drive unit for rotating the transparent panel has revolutions per minute determined by a vertical synchronizing frequency signal transmitted from the CCD camera of the camera body.

20. The device according to claim 18, wherein an installation angle of the transparent panel is changed with respect to an optical axis of the group of camera lenses.

21. The device according to claim 15, wherein the transparent panel comprises a passage part and a plurality of refracting parts having different refractive indices from one another.

22. The device according to claim 21, wherein the rotating drive unit for rotating the transparent panel has revolutions per minute determined by a vertical synchronizing frequency signal transmitted from the CCD camera of the camera body.

23. The device according to claim 21, wherein an installation angle of the transparent panel is changed with respect to an optical axis of the group of camera lenses.
